(19) United States
(12) Patent Application Publication
(10) Pub. No.: US 2008/0175216 A1
(43) Pub. Date: Jul. 24, 2008

(54) Data communications device for use with streetlights

(75) Inventor: Michael Nasco, Scottsdale, AZ (US)

Correspondence Address: FRANK J. MCGUE, 10801 N. 32ND STREET SUITE 5, PHOENIX, AZ, 85028, US

(73) Assignee: REW International, LLc

(21) Appl. No.: 11/998,182

(22) Filed: Nov. 29, 2007

Related U.S. Application Data
(60) Provisional application No. 60/881,991, filed on Jan. 23, 2007.

(51) Int. Cl. H04Q 7/24

(52) U.S. Cl. 370/338

(57) ABSTRACT

A data communications device is mountable in a variety of locations. The data communications device comprises a housing and a wireless communications device contained within the housing. An antenna mounted within the housing is in electrical communication with the wireless communications device and receives and transmits radio signals. A power plug for provides electrical power to the wireless communications device mounted in the housing.

### RELATED APPLICATION

This application is a continuation-in-part of co-pending application Ser. No. 60/881,991 filed Jan. 23, 2007.

### TECHNICAL FIELD

This invention relates generally to the field of data communications devices, and, more particularly, to a data communications device having an internal directional antennae instead of external omni-directional antenna.

### BACKGROUND OF THE INVENTION

In the modern world, data communications includes WiFi (which means Wireless Fidelity), WiMax, BPL (Broad Band over Powerlines), CDMA (Code Division Multiple Access), GPRS (General Packet Radio Service), EVDO (Evolution Data Optimized), EDGE (Enhanced Data Rate for Global Evolution), UMTS (Universal Mobile Telecommunications System), HSDPA (High Speed Download Packet Access), PLC (powerline controller), cellular, wired and wireless transport of broadband internet voice data video traffic, GSM (Groupe Special Mobile) or any combination thereof. It also permits a local (“neighborhood”) wired and wireless network to exist and to connect to a larger network or internet.

One embodiment of the present invention uses existing streetlights for power and mounting to facilitate such data communications. Streetlights are well known in the art and are known as street lights, street lamps, light standards or lamp standards in various areas of the country. A streetlight is a tall light source positioned on the edge of a road, or in a parking lot, or other places needing rumination and is turned on at night to provide. Most streetlights now use either timers or photocells that are plugged into streetlights taps to be turned on and off.

Other devices use such taps or adapter cords that plug into streetlights in a similar way, however, these devices only power external devices attached to the streetlight. Typically, such taps provide power via external wires to things like remote cameras, etc. or as a power supply for remote electrical operations. Unlike these devices, the present invention is not essentially a “power strip” or an “extension cord”, it is a device that itself enables data communication networks which uses internal antennae requiring less weight and which do not protrude and which are adapted to be directly connected to such devices as the lamp head of an existing streetlight.

Some data communications devices are mounted on streetlights intrusively tap into power provided for the light and require more than the use of an existing plug outlet. However, current devices employ linear exterior antennae which extend upwardly and downwardly from the device which is usually affixed to the streetlight via brackets or, alternatively, to the light's supporting arm or pole. These unsightly antennae are not aesthetically pleasing. In addition, upwardly extending external antennae often cannot be deployed with permission of utility companies due to possible interference with overhanging power lines as shown in FIG. 1. Lastly, the brackets and the device itself are often bulky and heavy and are more difficult to install and can cause problems when hung on the horizontally extending portion of a streetlight. Streetlights may not be designed to handle the extra weight of the heavier devices and associated antennae.

Thus, there is a need for a data communications device which is lightweight, aesthetically move pleasing and easier and hence less expensive to install and which does not interfere with nearby power lines and the like.

U.S. Pat. No. 6,222,503 entitled “System and Method of Integrating and Concealing Antennas, Antenna Subsystems and Communications Subsytems” which issued on Apr. 24, 2001 to Gietema et al. discloses wireless repeaters in streetlamps (Element 6 in FIG. 1B; Col. 11, line 60).

U.S. Patent Application Publication No. 2004/0248511 entitled “Repeater for Telecommunications Network” which published on Dec. 9, 2004 to Flynn provides wireless repeaters on streetlights (Paras [0003] and [0065]).

U.S. Pat. No. 6,654,616 entitled “Wireless Area Network Having Flexible Backhauls for Creating Backhaul Network” which issued on Nov. 25, 2003 to Pope, Jr. et al. shows a broadband WLAN with lamppost microcel radioport (Element 20 in FIG. 3; Col. 4, lines 65-67).

U.S. Patent Application Publication No. 2005/0275430 entitled “Voltage Level Shifting Circuit and Method” which published on Dec. 15, 2005 to Griebling has a wireless access point on street light (FIG. 7; Par. [0053]).

None of the known prior art disclose the combination set forth herein.

### SUMMARY OF THE INVENTION

It is an object of this invention to provide data communications device which plugs into an existing streetlight for power and uses internal antennae to transmit signals.

Further objects and advantages of the invention will become apparent as the following description proceeds and the features of novelty which characterize this invention will be pointed out with particularity in the claims annexed to and forming a part of this specification.

### BRIEF DESCRIPTION OF THE DRAWINGS

The present invention may be more readily described by reference to the accompanying drawings in which:

FIG. 1 is a bottom and side perspective view of the present invention on a streetlight;

FIG. 2 is a top and side blow up view of the invention of FIG. 1;

FIG. 3 is a top partial cross sectional view of the invention;

FIG. 4 is perspective side and top view of the present invention;

FIG. 5 is a perspective side and bottom view of the present invention;

FIG. 6 shows the present invention used with a cord inserted into a standard wall plug;

FIG. 7 is a perspective top and side view of one embodiment of the present invention with the top thereof removed; and

FIG. 8 is a schematic showing how the present invention is used.

### DESCRIPTION OF THE PREFERRED EMBODIMENT

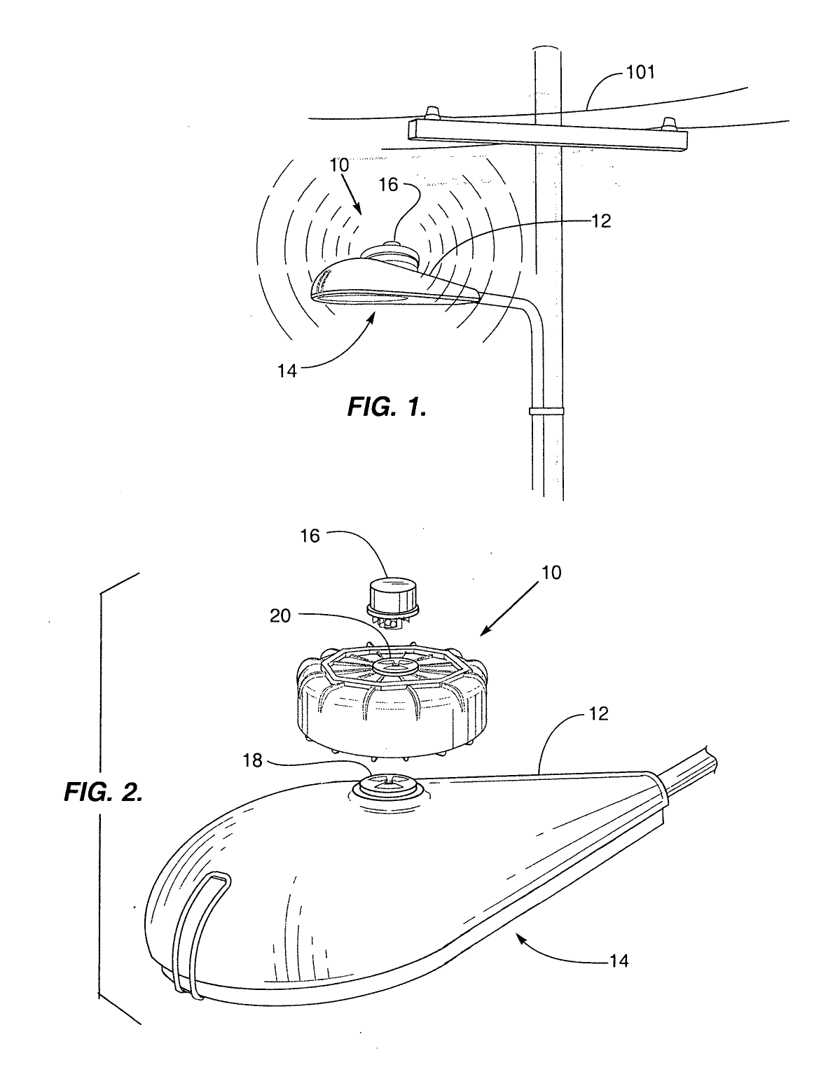

Referring more particularly to the drawings by characters of reference, FIGS. 1-5 disclose combinations of features which constitute the components of a data communications device 10 of the present invention. In the presently preferred embodiment, data communications device 10 is sandwiched between a top 12 of a streetlight 14 and transmits electrical power to a second electrical device, in the illustrated embodiment, a photocell 16.

In the prior art, photocell 16 plugs directly into a receptacle 18 provided on top 12 and turns streetlight 14 on or off depending upon the ambient light. In the present invention, device 10 includes an electrical plug 11 which plugs directly into receptacle 18 and photocell 16 then plugs into a device receptacle 20 positioned atop device 10. Photocell 16 functions identically as in the prior art, turning streetlight 14 on and off depending upon the ambient light.

The present invention uses electricity from receptacle 18 to power a standard communications device 22.

The individual components of the present invention are commercially available from a number of sources. Streetlights with receptacles are provided by such companies as Westinghouse, for example, their OV25 Silverliner® streetlights. Photocells are available from companies such as Precision Multiple Controls, Inc. of Midland Park, N.J. or EcoVantage Energy, Inc. Appropriate power taps are available from Whitehead Industries, Inc. of Northbrook, Ill. as Brad Harrison® Luminaire Power Taps. Suitable wireless communications devices are available from multiple sources such as Netgate.com of Kailua, Hi., Ituner Networks Corp. of Fremont, Calif. and Design of Systems on Silicon of Valencia, Spain.

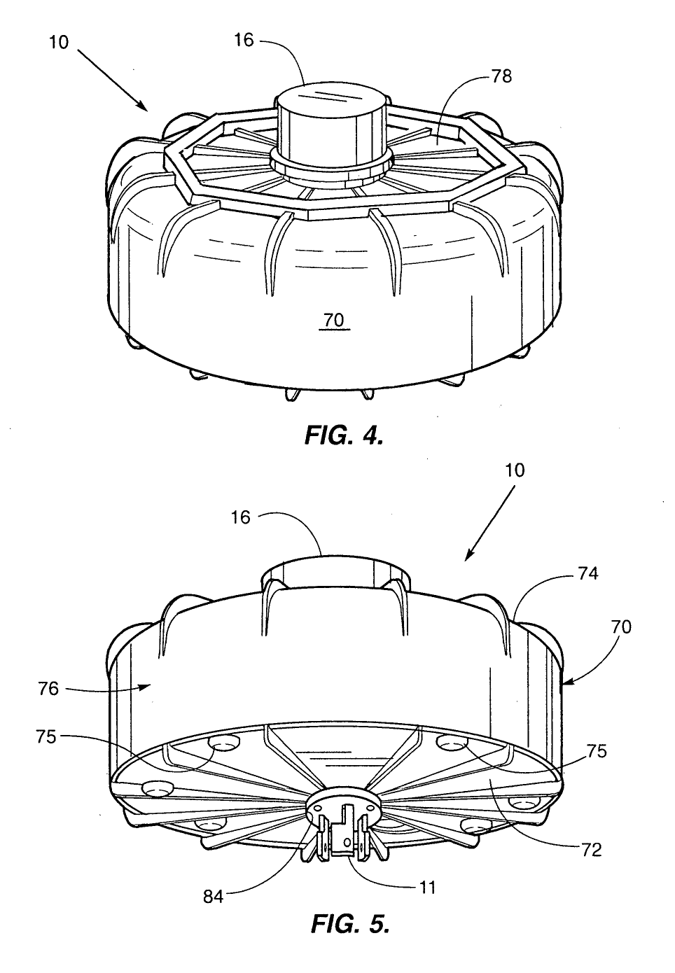

Turning now to FIGS. 4, 5 and 7, the present invention includes a housing 70 comprising a lower circular base 72 having a cover 74 mounted thereto. Cover 74 comprises a sidewall 76 forming a cylinder having an axis and inner diameter corresponding to that of circular base 72. A top 78 encloses the end of sidewall 76 opposite base 72. Base 72 and cover 74 define a cavity 80 for mounting and protecting communications device 22 therein. Base and cover 74 are preferably connected via a plurality of screws 75.

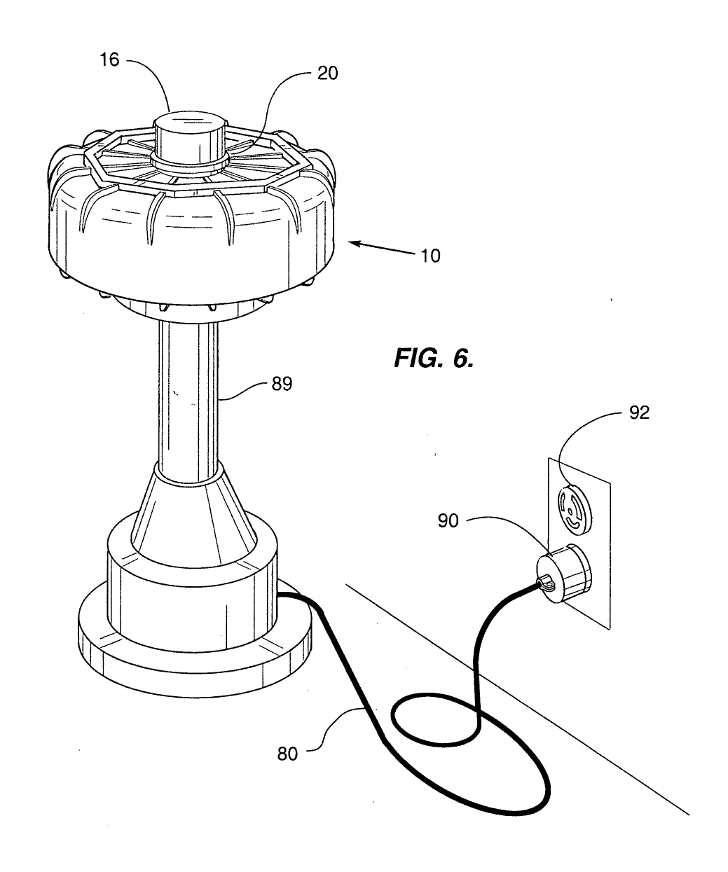

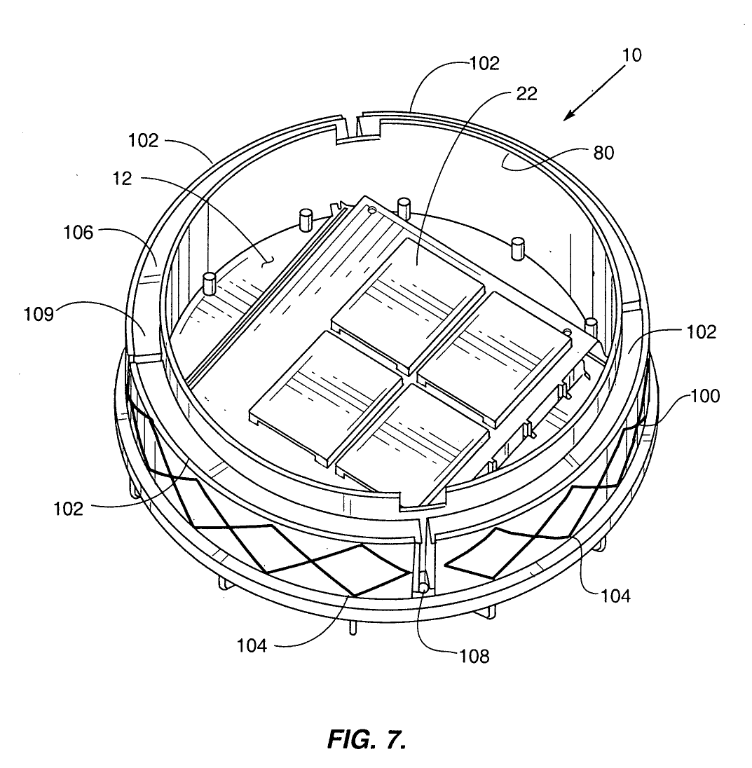

An upper opening 82 is centered on top 78 and a lower opening 84 is centered on base 72 for mounting device receptacle 20 and receptacle 18, respectively, to device 10. Device receptacle 20 and receptacle 18 can be modified for other uses. For example, in FIG. 6, device 10 mounts to a stand 89 and is connected to a plug 90 by a cord 88. In this embodiment, receptacle 18 is simply be a standard household plug 92. To allow a user to continue to use wall plug 90, device receptacle 20 would receive a standard plug 92 instead of the prior photocell 16.

Another important variant is shown in FIG. 7, namely, the use of an internal antennae 100 which have four functions, namely, aesthetics to avoid an unsightly external antenna, protection by having said antennae 100 contained within cavity 80 of housing 70, reduced weight by elimination of the need for heavy metal connectors to affix the external antennae and lastly to avoid outwardly extending antennae interfering with nearby power lines 101 and the like. In the illustrated embodiment, four curved walls 102 extend upwardly from base 72 forming an arc like structure contained within cavity 80. Arced fence antenna elements 104 are mounted to each wall 102 via insulator plugs 106 and electrical connectors 108. Antenna elements 104 are separated from corresponding wall 102 by foam 109 by a distance generally determined by the radio frequency employed. For example, an antenna transmitting at 15 millimeters wavelength would be separated from wall 102 by a distance equal to that wavelength. The four arced antenna elements 104, as shown, provide omnidirectional coverage for the radio signals therefrom.

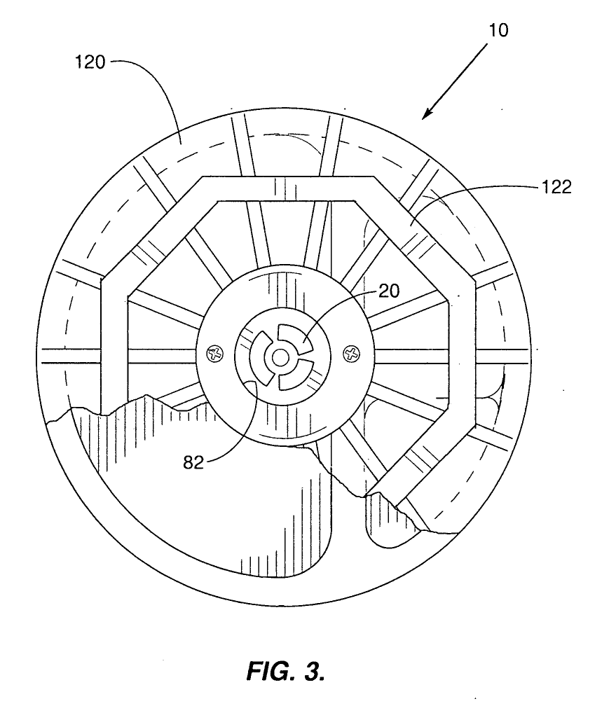

As another optional element is shown in FIG. 3 whereby a heat shield 120 is mounted atop cover 74 thereby providing shade to device 10. Heat shield 120 can further include an embedded antenna 122 in electrical communication with communications device 22 for transmitting radio signals therefrom.

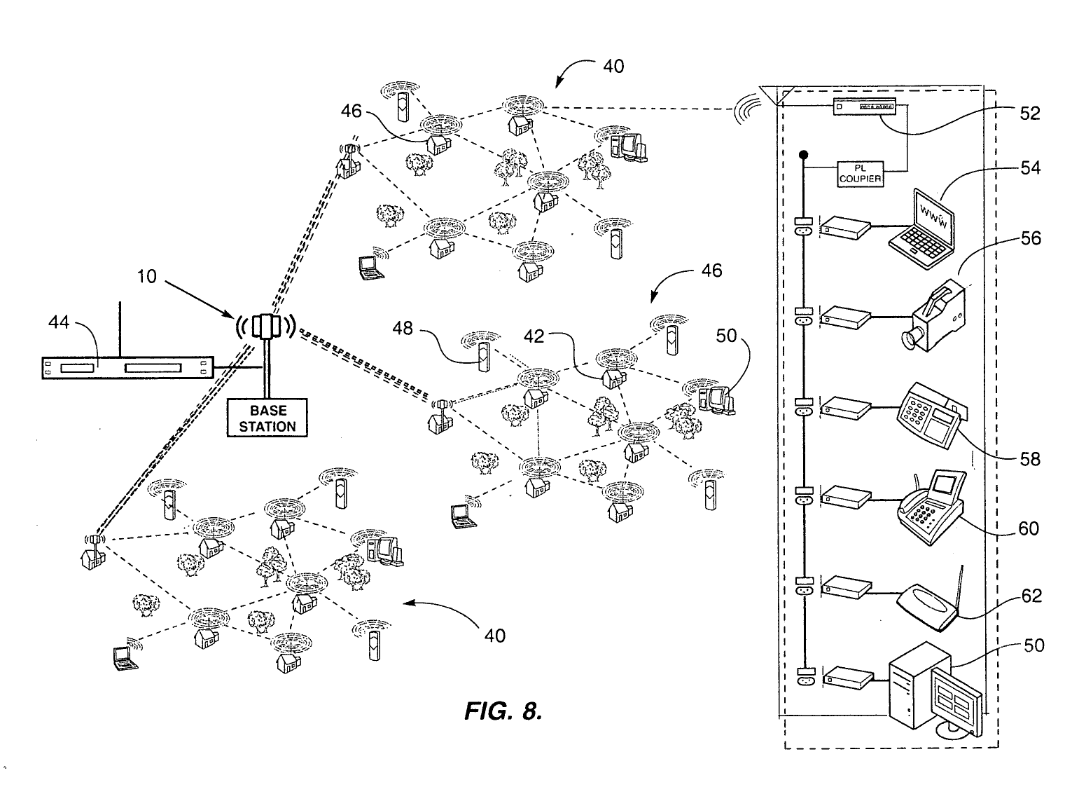

FIG. 8 shows the data communications device 10 interacting with three metropolitan area networks 40 as well as the internet 42 via a gateway 44. The illustrated gateway 44 is a Xfire Hopgate but those skilled in the art will recognize that many other systems would be compatible with the present invention. In addition, the metropolitan area networks 40 are shown to utilize HopWARE Mesh Architecture including Xnet Viper-II wireless systems 46 which interact with WiFi cellular phones 48 and desktop users 50. Such wireless systems 46 can also interact, via a PCL gateway 52 with laptop computer 54, digital camera 56, answering machine 58, telephone 60, wireless router 62 as well as desktop user 50.

Although only certain embodiments have been illustrated and described, it will be apparent to those skilled in the art that various changes and modifications may be made therein without departing from the spirit of the invention or from the scope of the appended claims.

That which is claimed is:

1. A data communications device which is mountable in a variety of locations, the data communications device comprising:
a housing,
a wireless communications device contained within the housing,
an antenna mounted within the housing in electrical communication with the wireless communications device for receiving and transmitting radio signals thereto; and
a power plug for providing electrical power to the wireless communications device mounted to the housing.

2. The data communications device of claim 1 wherein the power plug is a plug which connects directly to a receptacle positioned on top of a streetlight.

3. The data communications device of claim 1 wherein the power plug is a plug which connects to a wall plug.

4. The data communications device of claim 1 wherein the device further comprises a device receptacle for transmitting the electrical power to a second electrical device.

5. The data communications device of claim 4 wherein the second electrical device is a photocell for a streetlight.

6. The data communications device of claim 4 wherein the second electrical device is a wall plug outlet.

7. The data communications device of claim 1 for use with a streetlight having a receptacle positioned on top of the streetlight, the receptacle receiving a photocell therein for activating the streetlight when ambient light warrants same, the data communications device further comprising a device receptacle mounted atop the data communications device adapted to receive the photocell therein and wherein the power plug is a plug which connects to the receptacle.

8. The data communications device of claim 1 for use with a wall plug, the data communications device wherein the power plug is a plug which connects to the wall plug and the data communications device further comprising a device receptacle which is adapted to receive a wall plug outlet therein.

9. The communications device of claim 1 wherein the housing comprises a base and a cover mounted to the base, the base and the cover defining a cavity, the cavity containing the wireless communications device.

10. The communications device of claim 6 wherein the cover includes an upper opening and the base includes a lower opening, the upper opening and the lower opening providing means for mounting devices and receptacles thereon.

11. The data communications device of claim 1 wherein the internal antenna is a fence antenna mounted to one or more walls contained within the housing.

12. The data communications device of claim 1 wherein the wireless communications device interacts with area networks a variety of devices selected from a group comprising an internet gateway, wireless systems, cellular phones, desktop computers, laptop computers, handheld computers, digital cameras, digital monitors, answering machines, telephones and wireless routers.

13. The data communications device of claim 1 further comprising a heat shield mounted atop the housing.

14. The data communications device of claim 13 wherein the heat shield includes an embedded antenna in electrical communication with the wireless communication device for transmitting radio signals therefrom.

15. A data communications device for use with a streetlight having a receptacle positioned on top of the streetlight, the receptacle receiving a photocell therein for activating the streetlight when ambient light warrants same,
a housing having a base and a cover mounted to the base, the base and the cover defining a cavity,
a wireless communications device contained within the cavity,
an antenna mounted within the housing in electrical communication with the wireless communications device for receiving and transmitting radio signals thereto, the internal antenna being an arced fence antenna mounted to one or more walls contained within the housing;
a power plug for providing electrical power to the wireless communications device mounted to the housing, the power plug connecting directly to a receptacle positioned on top of a streetlight, and
a device receptacle mounted atop the data communications device adapted to receive the photocell.

16. The data communications device of claim 15 wherein the wireless communications device interacts with area networks a variety of devices selected from a group comprising an internet gateway, wireless systems, cellular phones, desktop computers, laptop computers, handheld computers, digital cameras, digital monitors, answering machines, telephones and wireless routers.

17. The data communications device of claim 15 further comprising a heat shield mounted atop the housing.

18. The data communications device of claim 17 wherein the heat shield includes an embedded antenna in electrical communication with the wireless communication device for transmitting radio signals therefrom.
